(19) United States
(12) Patent Application Publication
(10) Pub. No.: US 2024/0331358 A1
(43) Pub. Date: Oct. 3, 2024

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Aya OGASAWARA, Tokyo (JP)

(73) Assignee: FUJIFILM Corporation, Tokyo (JP)

(21) Appl. No.: 18/599,150

(22) Filed: Mar. 7, 2024

(30) Foreign Application Priority Data
Mar. 28, 2023 (JP) 2023-051233

(51) Int. Cl. G06V 10/774; G06T 11/00

(52) U.S. Cl. CPC G06V 10/774; G06T 11/00; G06T 2210/41; G06V 2201/031

(57) ABSTRACT

An image processing apparatus receives relationship information indicating a relationship between a plurality of partial regions in a target organ, and generates a medical image in which an indirect finding associated with occurrence of a lesion exists in the target organ based on the relationship information.

### CROSS-REFERENCE TO RELATED APPLICATIONS

This application claims priority from Japanese Patent Application No. 2023-051233, filed on Mar. 28, 2023, the entire disclosure of which is incorporated herein by reference.

### BACKGROUND

### 1. Technical Field

The present disclosure relates to an image processing apparatus, an image processing method, and an image processing program.

### 2. Description of the Related Art

JP2021-019677A discloses a technique of detecting an air space region on a first image obtained by imaging a cross section of a lung in which an air space is generated due to a first disease, and generating, based on the first image and a second image showing a shadow of a tumor due to a second disease that may cause complications with the first disease, a third image in which the first image is combined with the second image. In this technique, in a case in which the second image is disposed on the first image, the third image in which the first image is combined with the second image is generated by hiding a portion of the shadow of the tumor that overlaps the detected air space region.

### SUMMARY

In a case in which a trained model for detecting a lesion from a medical image is generated by machine learning, it is preferable to collect a large amount of learning data in order to improve detection accuracy of the lesion. In many cases, the lesion is discovered after the progression, and it may be difficult to collect a medical image of the lesion in an early stage. In this case, it is preferable to be able to accurately generate the medical image of the lesion in an early stage, because the generated medical image can be used for machine learning.

The present disclosure has been made in view of the above circumstances, and an object of the present disclosure is to provide an image processing apparatus, an image processing method, and an image processing program capable of accurately generating a medical image of a lesion in an early stage.

According to a first aspect, there is provided an image processing apparatus comprising: at least one processor, in which the processor receives relationship information indicating a relationship between a plurality of partial regions in a target organ, and generates a medical image in which an indirect finding associated with occurrence of a lesion exists in the target organ based on the relationship information.

A second aspect provides the image processing apparatus according to the first aspect, in which the relationship information is a numerical value indicating a difference in size of the plurality of partial regions.

A third aspect provides the image processing apparatus according to the first aspect, in which the relationship information is data in which a discriminable value is defined for each of a region of the target organ and the plurality of partial regions in the medical image, the data being created to satisfy a difference in size of the plurality of partial regions.

A fourth aspect provides the image processing apparatus according to any one of the first aspect to the third aspect, in which the target organ is a pancreas, and the plurality of partial regions include a pancreatic duct and a pancreatic parenchyma.

A fifth aspect provides the image processing apparatus according to any one of the first aspect to the third aspect, in which the target organ is a pancreas, and the plurality of partial regions include a head part, a body part, and a tail part.

According to a sixth aspect, there is provided an image processing method executed by a processor of an image processing apparatus, the method comprising: receiving relationship information indicating a relationship between a plurality of partial regions in a target organ; and generating a medical image in which an indirect finding associated with occurrence of a lesion exists in the target organ based on the relationship information.

According to a seventh aspect, there is provided an image processing program for causing a processor of an image processing apparatus to execute: receiving relationship information indicating a relationship between a plurality of partial regions in a target organ; and generating a medical image in which an indirect finding associated with occurrence of a lesion exists in the target organ based on the relationship information.

According to the present disclosure, it is possible to accurately generate a medical image of a lesion in an early stage.

### BRIEF DESCRIPTION OF THE DRAWINGS

FIG. 1 is a block diagram showing a schematic configuration of a medical information system.

FIG. 2 is a block diagram showing an example of a hardware configuration of an image processing apparatus.

FIG. 3 is a diagram showing an example of an indirect finding of a pancreatic cancer.

FIG. 4 is a diagram showing an example of an indirect finding of a pancreatic cancer.

FIG. 5 is a diagram showing an example of an indirect finding of a pancreatic cancer.

FIG. 6 is a block diagram showing an example of a functional configuration of the image processing apparatus.

FIG. 7 is a diagram for describing a trained model.

FIG. 8 is a diagram for describing relationship information.

FIG. 9 is a diagram for describing a process of generating a medical image using the trained model.

FIG. 10 is a flowchart showing an example of a medical image generation process.

FIG. 11 is a diagram for describing a process of generating a medical image using a trained model according to a modification example.

### DETAILED DESCRIPTION

Hereinafter, examples of an embodiment for implementing the technique of the present disclosure will be described in detail with reference to the drawings.

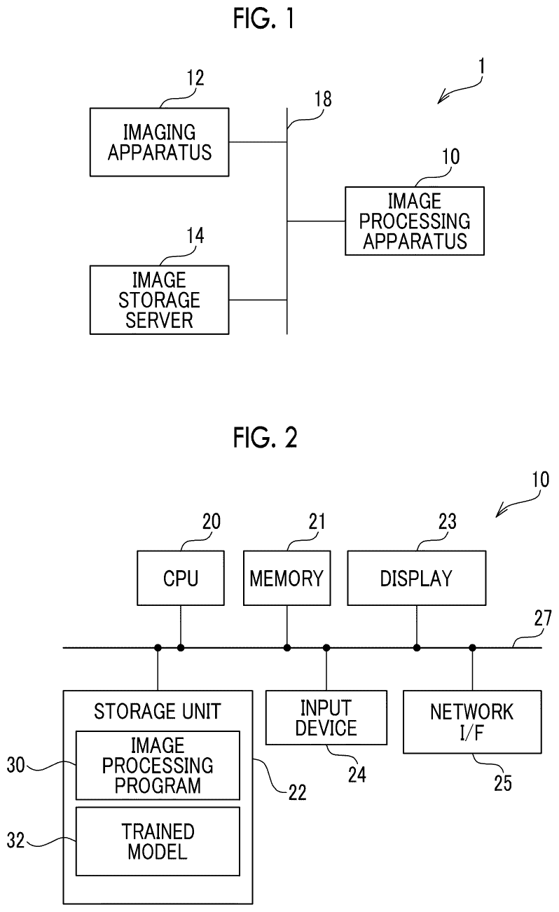

First, a configuration of a medical information system 1 according to the present embodiment will be described with reference to FIG. 1. As shown in FIG. 1, the medical information system 1 includes an image processing apparatus 10, an imaging apparatus 12, and an image storage server 14. The image processing apparatus 10, the imaging apparatus 12, and the image storage server 14 are connected to each other in a communicable manner via a wired or wireless network 18. The image processing apparatus 10 is, for example, a computer such as a personal computer or a server computer.

The imaging apparatus 12 is an apparatus that generates a medical image showing a diagnosis target part of a subject by imaging the part. Examples of the imaging apparatus 12 include a simple X-ray imaging apparatus, an endoscope apparatus, a computed tomography (CT) apparatus, a magnetic resonance imaging (MRI) apparatus, and a positron emission tomography (PET) apparatus. In the present embodiment, an example will be described in which the imaging apparatus 12 is a CT device and the diagnosis target part is an abdomen. That is, the imaging apparatus 12 according to the present embodiment generates a CT image of the abdomen of the subject as a three-dimensional medical image formed of a plurality of tomographic images. The medical image generated by the imaging apparatus 12 is transmitted to the image storage server 14 via the network 18 and stored by the image storage server 14.

The image storage server 14 is a computer that stores and manages various types of data, and comprises a large-capacity external storage device and database management software. The image storage server 14 receives the medical image generated by the imaging apparatus 12 via the network 18, and stores and manages the received medical image. A storage format of image data by the image storage server 14 and the communication with another device via the network 18 are based on a protocol such as digital imaging and communication in medicine (DICOM).

Next, a hardware configuration of the image processing apparatus 10 according to the present embodiment will be described with reference to FIG. 2. As shown in FIG. 2, the image processing apparatus 10 includes a central processing unit (CPU) 20, a memory 21 as a temporary storage region, and a non-volatile storage unit 22. In addition, the image processing apparatus 10 includes a display 23 such as a liquid crystal display, an input device 24 such as a keyboard and a mouse, and a network interface (I/F) 25 that is connected to the network 18. The CPU 20, the memory 21, the storage unit 22, the display 23, the input device 24, and the network I/F 25 are connected to a bus 27. The CPU 20 is an example of a processor according to the technique of the present disclosure.

The storage unit 22 is realized by a hard disk drive (HDD), a solid state drive (SSD), a flash memory, or the like. An image processing program 30 is stored in the storage unit 22 as a storage medium. The CPU 20 reads out the image processing program 30 from the storage unit 22, expands the image processing program 30 in the memory 21, and executes the expanded image processing program 30.

In addition, a trained model 32 is stored in the storage unit 22. Details of the trained model 32 will be described below.

Incidentally, in order to discover the lesion early, it is preferable to collect a medical image of the lesion in an early stage. This is because the medical image can be used for, for example, machine learning. However, in some cases, the lesion is rarely discovered early and is discovered after the progression. In this case, it is preferable to be able to generate the medical image of the lesion in an early stage, because the medical image of the lesion in an early stage is rare.

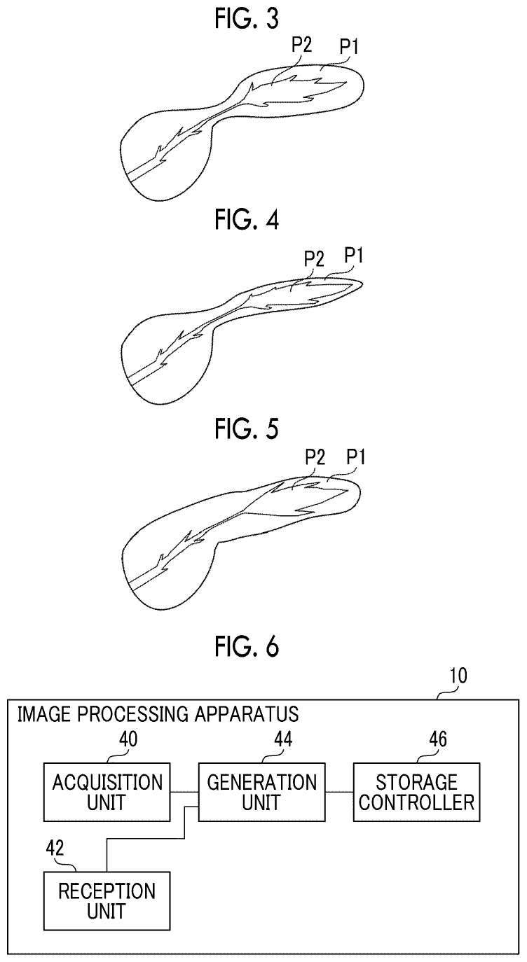

In an early stage of the lesion, a plurality of partial regions in a target organ may have specific features. Specifically, for example, in a case of a pancreatic cancer, in an early stage, a plurality of types of features are noted as an indirect finding. For example, as shown in FIG. 3, there is known an indirect finding that a pancreatic duct P2 is narrowed at a position where a pancreatic parenchyma P1 is locally constricted. In addition, for example, as shown in FIG. 4, there is known an indirect finding that the pancreatic parenchyma is generally atrophied on a tail part side of the pancreas from a position where the pancreatic duct P2 is narrowed. In addition, for example, as shown in FIG. 5, there is known an indirect finding that the pancreatic parenchyma P1 has a normal shape, but the pancreatic duct P2 is rapidly narrowed.

Therefore, the image processing apparatus 10 according to the present embodiment has a function of generating a medical image of a lesion in an early stage based on a relationship between a plurality of partial regions in the target organ. In the following, an example will be described in which the pancreas is applied as the target organ, the pancreatic cancer is applied as the lesion, and the pancreatic duct and the pancreatic parenchyma are applied as the plurality of partial regions in the pancreas.

Next, a functional configuration of the image processing apparatus 10 according to the present embodiment will be described with reference to FIG. 6. As shown in FIG. 6, the image processing apparatus 10 includes an acquisition unit 40, a reception unit 42, a generation unit 44, and a storage controller 46. The CPU 20 executes the image processing program 30 to function as the acquisition unit 40, the reception unit 42, the generation unit 44, and the storage controller 46.

The acquisition unit 40 acquires a healthy-state medical image in which a lesion has not occurred in the target organ (hereinafter, referred to as a “normal medical image”) from the image storage server 14 via the network I/F 25. The reception unit 42 receives information (hereinafter, referred to as “relationship information”) indicating a relationship between a plurality of partial regions in the target organ. In the present embodiment, an example will be described in which a numerical value indicating a difference in size of the plurality of partial regions is used as the relationship information. The relationship information is input by a user via the input device 24, for example.

The generation unit 44 generates a medical image in which an indirect finding associated with occurrence of a lesion exists in the target organ based on the normal medical image acquired by the acquisition unit 40, the relationship information received by the reception unit 42, and the trained model 32.

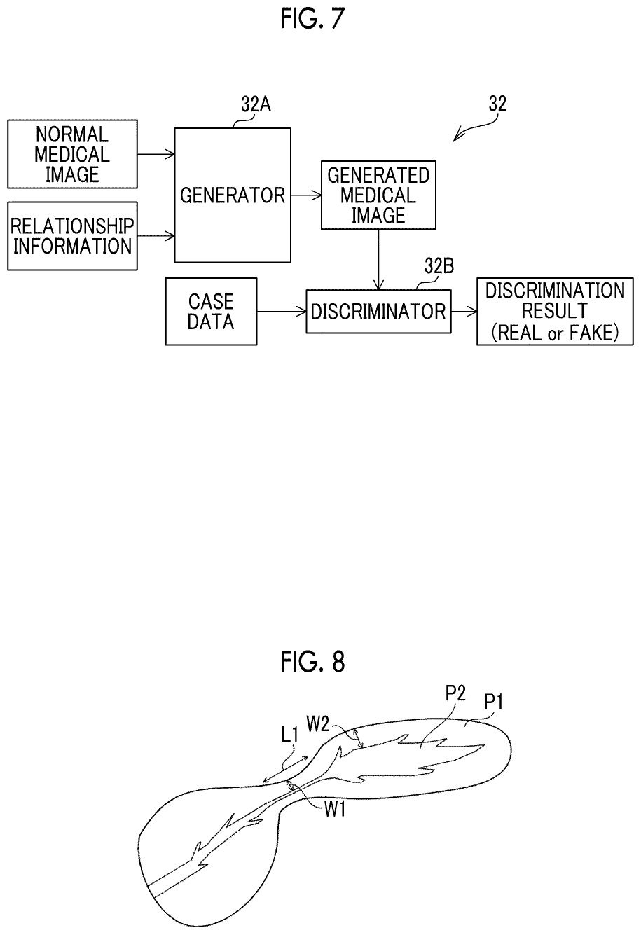

Details of the trained model 32 will be described with reference to FIG. 7. The trained model 32 according to the present embodiment is a generative model called a generative adversarial network (GAN). As shown in FIG. 7, the trained model 32 includes a generator 32A and a discriminator 32B. Each of the generator 32A and the discriminator 32B is configured by, for example, a convolutional neural network (CNN).

In a learning phase, a set of the normal medical image and the relationship information is input to the generator 32A as learning data. In the present embodiment, as shown in FIG. 8 as an example, W1:W2:L1, which is a ratio (hereinafter, referred to as a “size ratio”) representing a difference in size of a plurality of partial regions, is input to the generator 32A as the relationship information. W1 is a difference in diameter between the pancreatic parenchyma P1 and the pancreatic duct P2 at a position where the narrowing of the pancreatic duct P2 occurs. W2 is a difference in diameter between the pancreatic parenchyma P1 and the pancreatic duct P2 in the tail part of the pancreas. L1 is a length of a portion where the pancreatic duct P2 is narrowed. W1:W2:L1 is set to a value satisfying a size ratio in a case in which each of the above-described indirect findings (see FIGS. 3 to 5) occurs. The generator 32A generates and outputs a medical image in which an indirect finding associated with occurrence of a lesion exists in the target organ by changing a contour of a plurality of partial regions of the target organ in the input normal medical image based on the relationship information. Hereinafter, the medical image generated by the generator 32A is referred to as a “generated medical image”. The size ratio may be a ratio of any two of W1, W2, and L1. In addition, the size ratio may be a volume ratio or the like.

The discriminator 32B discriminates whether the generated medical image is a real medical image or a fake medical image by comparing prepared case data with the generated medical image output from the generator 32A. Then, the discriminator 32B outputs information indicating whether the generated medical image is a real medical image or a fake medical image as a discrimination result. As the discrimination result, a probability that the generated medical image is a real medical image is used. In addition, as the discrimination result, two values such as “1” indicating that the generated medical image is a real medical image and “0” indicating that the generated medical image is a fake medical image are used. The case data according to the present embodiment is an actual medical image obtained by imaging, with the imaging apparatus 12, a patient in whom an indirect finding of the pancreatic cancer in an early stage has occurred. In addition, the case data is prepared in advance for each of a plurality of different size ratios, and the case data corresponding to the size ratio input to the generator 32A is input to the discriminator 32B.

The generator 32A is trained to be able to generate a generated medical image closer to a real medical image (that is, case data). The discriminator 32B is trained to more accurately discriminate whether the generated medical image is a fake medical image. For example, a loss function in which a loss of the discriminator 32B increases as a loss of the generator 32A decreases is used to perform learning such that the loss of the generator 32A is minimized in training the generator 32A. On the other hand, the loss function is used to perform learning such that the loss of the discriminator 32B is minimized in training the discriminator 32B. The trained model 32 is a model obtained by alternately training the generator 32A and the discriminator 32B using a large amount of learning data.

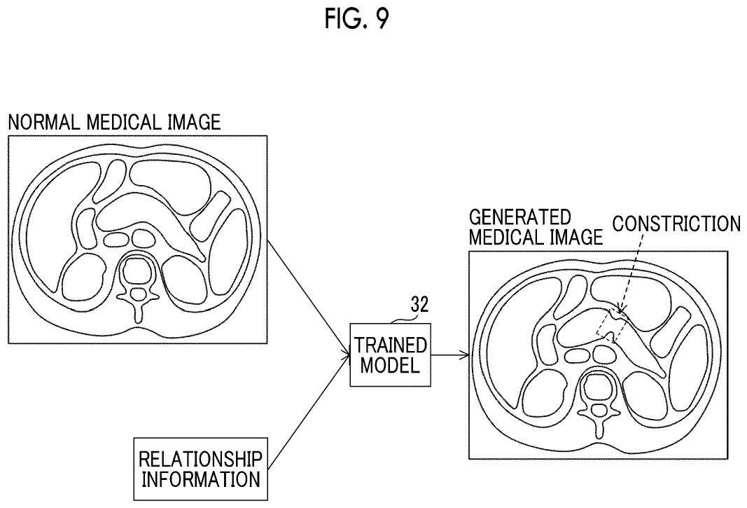

As shown in FIG. 9, the generation unit 44 inputs the normal medical image acquired by the acquisition unit 40 and the relationship information received by the reception unit 42 to the trained model 32. The trained model 32 generates a medical image in which an indirect finding associated with occurrence of a lesion exists in the target organ of the normal medical image. FIG. 9 shows an example in which the trained model 32 outputs a medical image in which localized pancreatic atrophy (so-called constriction), which is an example of an indirect finding of the pancreatic cancer in an early stage, exists.

The storage controller 46 performs control to store the generated medical image generated by the generation unit 44 in the storage unit 22.

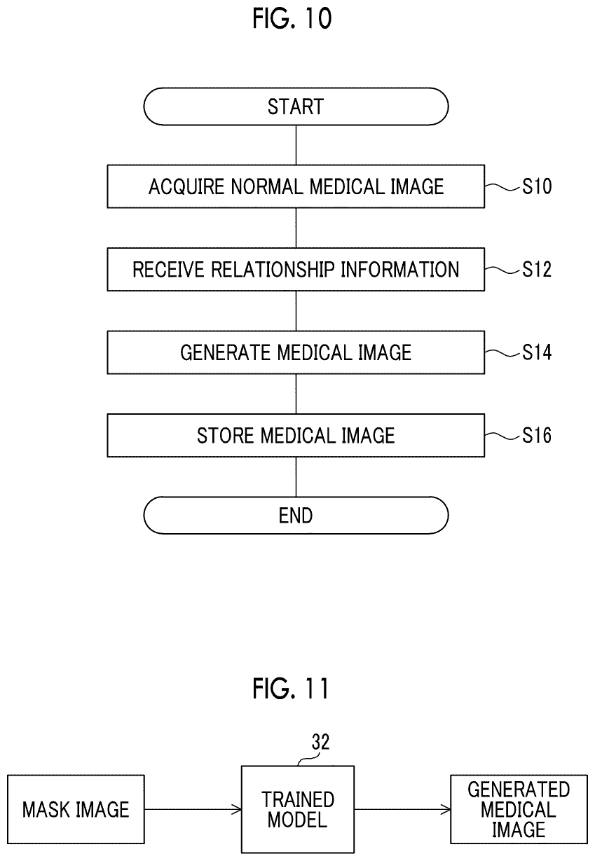

Next, an operation of the image processing apparatus 10 according to the present embodiment will be described with reference to FIG. 10. The CPU 20 executes the image processing program 30 to execute a medical image generation process shown in FIG. 10. The medical image generation process shown in FIG. 10 is executed, for example, in a case in which an instruction to start an execution is input by the user.

In step S10 of FIG. 10, the acquisition unit 40 acquires the normal medical image from the image storage server 14 via the network I/F 25. In step S12, the reception unit 42 receives the relationship information. In step S14, as described above, the generation unit 44 generates a medical image in which an indirect finding associated with occurrence of a lesion exists in the target organ, based on the normal medical image acquired in step S10, the relationship information received in step S12, and the trained model 32.

In step S16, the storage controller 46 performs control to store the medical image generated in step S14 in the storage unit 22. In a case in which the process in step S16 ends, the medical image generation process ends.

As described above, according to the present embodiment, it is possible to accurately generate a medical image of a lesion in an early stage. In addition, by executing the medical image generation process on each of a plurality of sets of the normal medical image and the relationship information, a plurality of the generated medical images can be obtained. The plurality of generated medical images obtained as described above are used for training a trained model for detecting a lesion in an early stage from a medical image.

In the above embodiment, a case in which a numerical value indicating a difference in size of a plurality of partial regions is applied as the relationship information by the generation unit 44 has been described, but the present disclosure is not limited to this. As the relationship information, data in which a discriminable value is defined for each of a region of the target organ and the plurality of partial regions in the medical image, the data being created to satisfy a difference in size of the plurality of partial regions, may be applied. As an example of the data, an image (hereinafter, referred to as a “mask image”) is used in which “1” is stored in a voxel of a region of the pancreas, “2” is stored in a voxel of a region of the pancreatic parenchyma, and “3” is stored in a voxel of a region of the pancreatic duct. In addition, the mask image is created such that W1:W2:L1 satisfies a size ratio in a case in which the indirect finding described above is generated.

Specifically, as shown in FIG. 11, the generation unit 44 inputs the mask image to the trained model 32. The trained model 32 outputs a medical image in which an indirect finding associated with occurrence of a lesion exists in the target organ based on the mask image. The trained model 32 in this embodiment example is also obtained by training the generator 32A and the discriminator 32B based on the mask image and the case data as in the above-described embodiment example.

In addition, in the above embodiment, a case in which the pancreatic duct and the pancreatic parenchyma are applied as the plurality of partial regions in the pancreas, which is the target organ, has been described, but the present disclosure is not limited to this. For example, a head part, a body part, and a tail part of the pancreas may be applied as the plurality of partial regions in the pancreas. Examples of the size ratio in this case include a ratio of volumes, a ratio of diameters, and a ratio of cross-sectional areas of the head part, the body part, and the tail part. In addition, as the plurality of partial regions in the pancreas, the pancreatic duct in the head part, the pancreatic duct in the body part, and the pancreatic duct in the tail part may be applied. In addition, the target organ is not limited to the pancreas, and may be an organ other than the pancreas.

In the above embodiment, a case in which the generator 32A and the discriminator 32B are configured by the CNN has been described, but the present disclosure is not limited to this. The generator 32A and the discriminator 32B may be configured by a machine learning method other than the CNN.

In addition, in the above embodiment, a case in which a CT image is applied as the medical image has been described, but the present disclosure is not limited to this. As the medical image, a medical image other than the CT image, such as a radiation image captured by a simple X-ray imaging apparatus and an MRI image captured by an MRI apparatus, may be applied.

In addition, in the above embodiment, for example, as hardware structures of processing units that execute various kinds of processing, such as the acquisition unit 40, the reception unit 42, the generation unit 44, and the storage controller 46, various processors shown below can be used. The various processors include, as described above, in addition to a CPU, which is a general-purpose processor that functions as various processing units by executing software (program), a programmable logic device (PLD) that is a processor of which a circuit configuration may be changed after manufacture, such as a field programmable gate array (FPGA), and a dedicated electrical circuit which is a processor having a circuit configuration specially designed to execute specific processing, such as an application specific integrated circuit (ASIC).

One processing unit may be configured of one of the various processors, or may be configured of a combination of the same or different kinds of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, there is an aspect in which one processor is configured of a combination of one or more CPUs and software, and this processor functions as a plurality of processing units. Second, as typified by a system on chip (SoC) or the like, there is an aspect in which a processor that implements functions of the entire system including the plurality of processing units via one integrated circuit (IC) chip is used. As described above, various processing units are configured by using one or more of the various processors as a hardware structure.

Further, as the hardware structure of the various processors, more specifically, an electric circuit (circuitry) in which circuit elements such as semiconductor elements are combined may be used.

In the embodiment, an aspect has been described in which the image processing program 30 is stored (installed) in the storage unit 22 in advance, but the present disclosure is not limited to this. The image processing program 30 may be provided in an aspect in which the image processing program 30 is recorded in a recording medium, such as a compact disc read only memory (CD-ROM), a digital versatile disc read only memory (DVD-ROM), and a universal serial bus (USB) memory. In addition, the image processing program 30 may be downloaded from an external device via a network.

What is claimed is:

1. An image processing apparatus comprising:
at least one processor,
wherein the processor
receives relationship information indicating a relationship between a plurality of partial regions in a target organ, and
generates a medical image in which an indirect finding associated with occurrence of a lesion exists in the target organ based on the relationship information.

2. The image processing apparatus according to claim 1,
wherein the relationship information is a numerical value indicating a difference in size of the plurality of partial regions.

3. The image processing apparatus according to claim 1,
wherein the relationship information is data in which a discriminable value is defined for each of a region of the target organ and the plurality of partial regions in the medical image, the data being created to satisfy a difference in size of the plurality of partial regions.

4. The image processing apparatus according to claim 1,
wherein the target organ is a pancreas, and
the plurality of partial regions include a pancreatic duct and a pancreatic parenchyma.

5. The image processing apparatus according to claim 1,
wherein the target organ is a pancreas, and
the plurality of partial regions include a head part, a body part, and a tail part.

6. An image processing method executed by a processor of an image processing apparatus, the method comprising:
receiving relationship information indicating a relationship between a plurality of partial regions in a target organ; and
generating a medical image in which an indirect finding associated with occurrence of a lesion exists in the target organ based on the relationship information.

7. A non-transitory computer-readable storage medium storing an image processing program for causing a processor of an image processing apparatus to execute:
receiving relationship information indicating a relationship between a plurality of partial regions in a target organ; and
generating a medical image in which an indirect finding associated with occurrence of a lesion exists in the target organ based on the relationship information.
